(19) United States
(12) Patent Application Publication
(10) Pub. No.: US 2013/0242974 A1
(43) Pub. Date: Sep. 19, 2013

(54) Method and Apparatus for Synchronization Mechanisms in Wireless Communication Systems

(71) Applicant: HTC CORPORATION, Taoyuan County (TW)

(72) Inventor: Chi-Fang Li, Taoyuan County (TW)

(73) Assignee: HTC CORPORATION, Taoyuan County (TW)

(21) Appl. No.: 13/845,101

(22) Filed: Mar. 18, 2013

Related U.S. Application Data
(60) Provisional application No. 61/612,407, filed on Mar. 19, 2012.

(51) Int. Cl. H04W 56/00

(52) U.S. Cl. CPC H04W 56/00
USPC 370/350

(57) ABSTRACT

A method for synchronization mechanism in a wireless communication network supporting new carrier type is disclosed. The method comprises generating a primary synchronization signal (PSS) and a secondary synchronization signal (SSS); transmitting a pair of the PSS and the SSS on a first carrier by a first mechanism; and transmitting a pair of the PSS and the SSS on a second carrier by a second mechanism; wherein the second carrier is of new carrier type.

### CROSS REFERENCE TO RELATED APPLICATIONS

This application claims the benefit of U.S. Provisional Application No. 61/612,407, filed on Mar. 19, 2012, entitled “Method and Apparatus for Multiple Synchronization Mechanism in Communication Systems”, the contents of which are incorporated herein in their entirety.

### BACKGROUND OF THE INVENTION

1. Field of the Invention

The invention relates to a method and apparatus utilized in a wireless communication system, and more particularly, to a method and apparatus for synchronization mechanisms in a wireless communication system.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), uplink (UL) multiple-input multiple-output (MIMO), new carrier type, etc. For a UE and an eNB to communicate with each other in the LTE-A system, the UE and the eNB must support standards developed for the LTE-A system, such as the 3GPP Rel-10 standard or later versions.

In the prior art, a UE has to perform synchronization before starting access or communications with a network (e.g. a cell of an eNB). In brief, the UE firstly detects a primary synchronization signal (PSS) and a secondary synchronization signal (SSS) transmitted by the network and follows to synchronize the local timing of the UE with that of the network. Accordingly, the UE can access the network.

Please refer to FIG. 1, which is a schematic diagram of a frame structure 10 in a network of a wireless communication system according to the prior art. In FIG. 1, an upper frame 100 is illustrated for a frame structure type 1. The upper frame has 10 subframes, the 10 subframes are partitioned into 20 slots SLOT0-SLOT19 (i.e. each subframe has 2 slots) and each slot has 7 OFDM symbols OS1_1-OS1_7. The lower frame 102 is illustrated for a frame structure type 2. The lower frame has 10 subframes SFRM0-SFRM9 and each subframe has 14 OFDM symbols OS2_1-OS21_4. In the conventional synchronization mechanism, for the frame structure type 1, the primary synchronization signal (PSS) is transmitted on the OFDM symbol OS1_7 in the slot SLOT0 and SLOT10, and the secondary synchronization signal (SSS) is transmitted twice on the OFDM symbol OS1_6 in the slot SLOT0 and SLOT10.

For the frame structure type 2, the PSS is transmitted twice on the OFDM symbol OS2_3 in the subframes SFRM1 and SFRM6, and the SSS is transmitted twice on the OFDM symbol OS2_7 in the subframes SFRM0 and SFRM5. Therefore, the UE can know the timing of the network by detecting the PSS and the SSS transmitted by the network and further synchronize the local timing of the UE with the network.

A new carrier type is going to be designed as being not compatible with legacy carrier or only partly supporting some features in legacy carrier. A legacy UE not supporting new carrier type may attempt to camp on a carrier in new carrier type by detecting the PSS and the SSS if the same PSS and SSS are transmitted as that in a legacy carrier. However, the legacy UE cannot access the network through a carrier in new carrier type. The attempt is unnecessary for the legacy UE and might cause extra delay and/or power consumption in its synchronization process. Therefore, it is necessary to provide a new synchronization mechanism for a new carrier type to generate the corresponding PSS and SSS and transmit them at proper time-frequency positions within the carrier bandwidth.

### SUMMARY OF THE INVENTION

The present invention provides a method and apparatus for synchronization mechanisms in a wireless communication system to prevent a communication device not supporting new carrier type from searching a carrier in new carrier type or at least to reduce the time spent on the unnecessary search.

The method comprises generating a primary synchronization signal (PSS) and a secondary synchronization signal (SSS); transmitting a pair of the PSS and the SSS on a first carrier by a first mechanism; and transmitting a pair of the PSS and the SSS on a second carrier by a second mechanism; wherein the second carrier is of new carrier type.

A communication apparatus comprises a processing means; a storage unit; and a program code, stored in the storage unit, wherein the program code instructs the processing means to execute the following steps: generating a PSS and a SSS; and transmitting a pair of the PSS and the SSS on a first carrier by a first mechanism; transmitting a pair of the PSS and the SSS on a second carrier by a second mechanism; wherein the second carrier is a new carrier type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a frame structure in a network of a wireless communication system according to the prior art.

FIG. 2 is a schematic diagram of a wireless communication system according to an example of the present invention.

FIG. 3 is a schematic diagram of a communication apparatus according to an example of the present invention.

FIG. 4 is a flowchart of a process according to an example of the present invention.

FIG. 5 is a flowchart of a process according to an example of the present invention.

FIG. 6 is a schematic diagram of locations allocated for the PSS and the SSS in a frequency domain in FIG. 5

FIG. 7 is a flowchart of a process according to an example of the present invention.

FIG. 8 is a flowchart of a process according to an example of the present invention.

### DETAILED DESCRIPTION

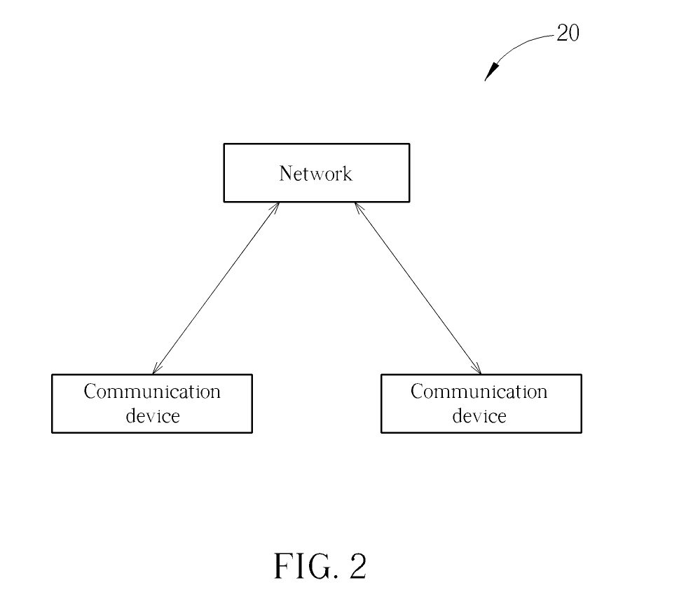

Please refer to FIG. 2, which is a schematic diagram of a wireless communication system 20 according to an example of the present invention. The wireless communication system 20 is briefly composed of a network and a plurality of communication devices. In FIG. 2, the network and the communication devices are simply utilized for illustrating the structure of the wireless communication system 20. Practically, the network can be a universal terrestrial radio access network (UTRAN) comprising a plurality of Node-Bs (NBs) in a universal mobile telecommunications system (UMTS). Alternatively, the network can be an evolved UTRAN (E-UTRAN) comprising a plurality of evolved NBs (eNBs) and/or relays in a long term evolution (LTE) system or a LTE-Advanced (LTE-A) system.

Furthermore, the network can also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a communication device, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. Besides, the information can be processed by both the UTRAN/E-UTRAN and the core network, and the decisions are made after coordination and/or cooperation are performed by the UTRAN/E-UTRAN and the core network.

The communication devices can be mobile communication devices such as user equipments for performing speech and data communication through the network such as the UMTS, the LTE system or the LTE-A system. Besides, the network and one of the communication devices can be seen as a transmitter or a receiver according to transmission direction, e.g., for an uplink (UL), the one of the communication devices is the transmitter and the network is the receiver, and for a downlink (DL), the network is the transmitter and the one of the communication devices is the receiver.

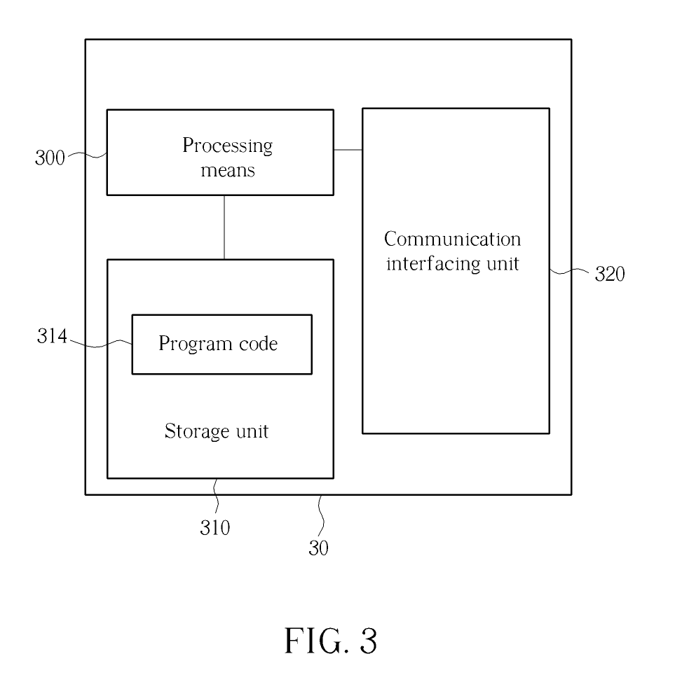

Please refer to FIG. 3, which is a schematic diagram of a communication device 30 according to an example of the present invention. The communication device 30 can be a communication device or the network shown in FIG. 2, but is not limited herein. The communication device 30 may include a processing means 300 such as a microprocessor or Application Specific Integrated Circuit (ASIC), a storage unit 310 and a communication interfacing unit 320. The storage unit 310 maybe any data storage device that can store a program code 314, accessed and executed by the processing means 300. Examples of the storage unit 310 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 320 is preferably a transceiver and is used to transmit and receive signals (e.g., messages or packets) according to processing results of the processing means 300.

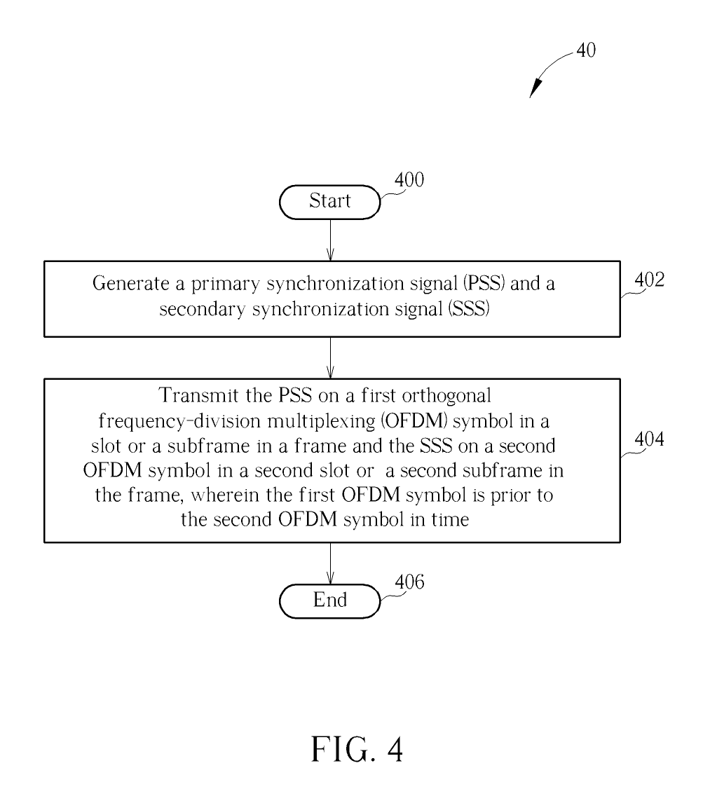

Please refer to FIG. 4, which is a flowchart of a process 40 according to an example of the present invention. The process 40 is utilized in the wireless communication system 20 shown in FIG. 4, for synchronization mechanism in a network supporting new carrier type. The process 40 can be utilized in the network and may be compiled into the program code 314. The process 40 includes the following steps:

Step 400: Start.

Step 402: Generate a primary synchronization signal (PSS) and a secondary synchronization signal (SSS).

Step 404: Transmit the PSS on a first orthogonal frequency-division multiplexing (OFDM) symbol in a slot or a subframe in a frame and the SSS on a second OFDM symbol in a second slot or a second subframe in the frame, wherein the first OFDM symbol is prior to the second OFDM symbol in time.

Step 406: End.

According to the process 40, the network generates the PSS and the SSS for the communication devices to detect and synchronize with the network. The PSS and the SSS are respectively transmitted in the first and second OFDM symbols and the first OFDM symbol is prior to the second OFDM symbol in time. In other words, the transmission of the PSS is prior to the transmission of the SSS in time.

In Step 404, the second OFDM symbol used for SSS transmission can be any one symbol following the first OFDM symbol used for PSS transmission in the same slot (i.e. the first slot and the second slot are the same one) or two slots (i.e. the first slot and the second slot are different ones) within a frame.

Note that, the process 40 is an example of the present invention, and those skilled in the art should readily make combinations, modifications and/or alterations on the abovementioned description and examples. For example, for the frame structure type 1, the PSS may be transmitted twice on the OFDM symbol OS1_6 in the slots SLOT0 and SLOT10 in the frame, and the SSS may be transmitted twice on the OFDM symbol OS1_7 in the slots SLOT0 and SLOT10 in the frame. For the frame structure type 2, the PSS is transmitted twice on the OFDM symbol OS2_14 in the subframe SFRM0 and SFRM5 in the frame, and the SSS can be transmitted twice on the OFDM symbol OS2_3 in the subframe SFRM1 and SFRM6 in the frame. In brief, the main difference between the synchronization mechanism in the process 40 and the conventional synchronization mechanism is that the order for transmitting the PSS and the SSS is different, so that a legacy communication device not supporting new carrier type cannot synchronize to the network and the legacy communication device will not waste time on camping on the unsuitable network.

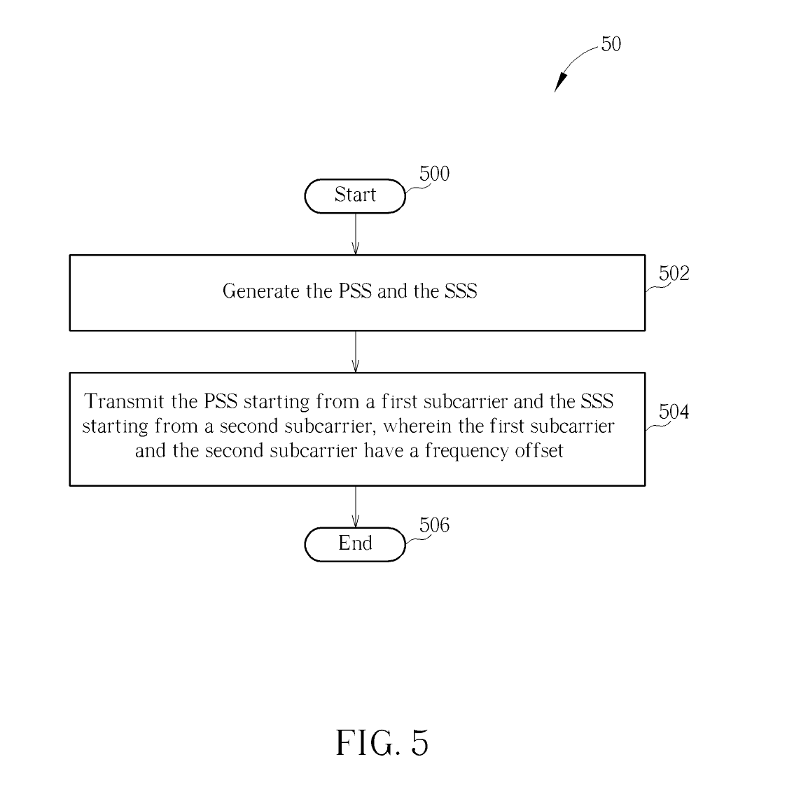

Please refer to FIG. 5, which is a flowchart of a process 50 according to an example of the present invention. The process 50 is utilized in the wireless communication system 20 shown in FIG. 5, for synchronization mechanism in a network supporting new carrier type. The process 50 can be utilized in the network and may be compiled into the program code 314. The process 50 includes the following steps:

Step 500: Start.

Step 502: Generate the PSS and the SSS.

Step 504: Transmit the PSS starting from a first subcarrier and the SSS starting from a second subcarrier, wherein the first subcarrier and the second subcarrier have a frequency offset.

Step 506: End.

According to the process 50, the network generates the PSS and the SSS and further transmits the PSS and the SSS on different subcarriers. Since the first subcarrier and the second subcarrier are different, a legacy communication device cannot detect both of the PSS and the SSS successfully and will not waste time on camping on the unsuitable network.

Note that, the process 50 is an example of the present invention, and those skilled in the art should readily make combinations, modifications and/or alterations on the abovementioned description and examples. For example, a relationship of the first subcarrier, the second subcarrier and the frequency offset may be described according to a specified algorithm. The specified algorithm may be described as follows:

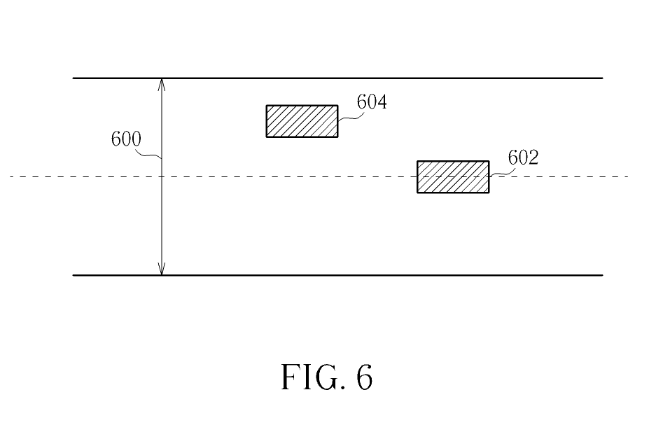

SC2=SC1+RE_OFFSET;

where—(N_{RB}^{DL}−3)N_{SC}^{RB}<RE_OFFSET<(N_{RB}^{DL}−3)N_{SC}^{RB}

wherein SC1 is the first subcarrier used for starting PSS transmission, the SC2 is the second subcarrier used for starting SSS transmission, the RE_OFFSET is the specific frequency offset, N_{RB}^{DL} is a number of resource blocks in a downlink transmission and N_{SC}^{RB} is a number of subcarriers in a resource block. The specified algorithm can be modified by those skilled in the art as long as the first and second subcarriers corresponding to the specific frequency offset conform to the system bandwidth and the communication device capable bandwidth. Please refer to FIG. 6, which is an example of schematic diagram of locations allocated for the PSS and the SSS in a frequency domain in FIG. 5. A location 602 is used for transmitting the PSS, and a location 604 is used for transmitting the SSS. The two locations used for PSS and SSS transmissions are not aligned in frequency domain. For example, the location 602 is allocated in the center of the system bandwidth 600 of the network. The location 604 is not allocated in the center of the system bandwidth 600 of the network. Therefore, the PSS and the SSS are transmitted on non-aligned resource elements, so that a legacy communication device cannot synchronize to a carrier in new carrier type.

Note that FIG. 6 is used to illustrate the frequency-domain relationship between the PSS location 602 and the SSS location 604. The time relationship between the PSS location 602 and the SSS location 604 can also be changed as the PSS location 602 followed by the SSS location 604. In this case, it is a combination of this method and the previous one in FIG. 4.

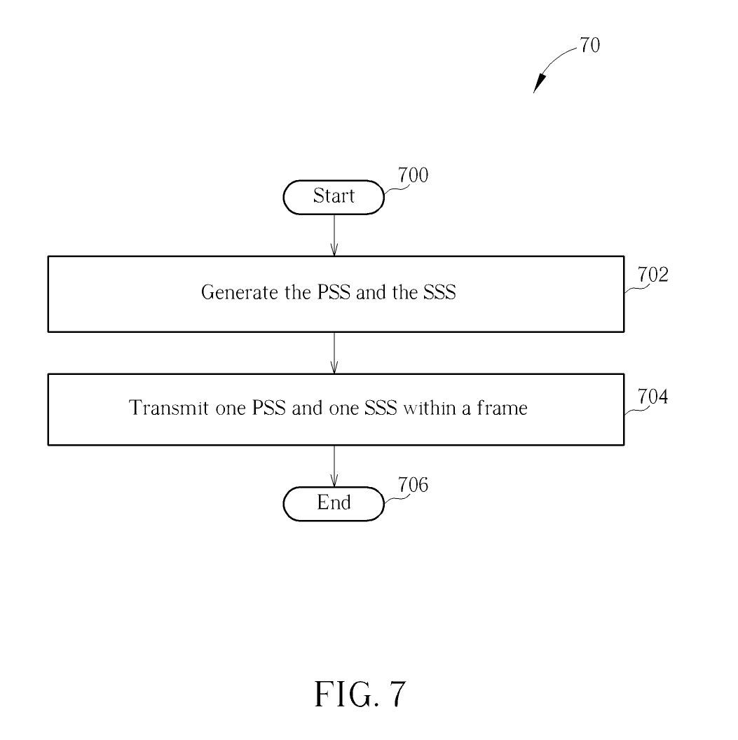

Please refer to FIG. 7, which is a flowchart of a process 70 according to an example of the present invention. The process 70 is utilized in the wireless communication system 20 shown in FIG. 7, for synchronization mechanism in a network supporting new carrier type. The process 70 can be utilized in the network and may be compiled into the program code 314. The process 70 includes the following steps:

Step 700: Start.

Step 702: Generate the PSS and the SSS.

Step 704: Transmit one PSS and one SSS within a frame.

Step 706: End.

According to the process 70, the network transmits one PSS and one SSS in a frame instead of two of them for the conventional synchronization mechanism. As a result, a legacy communication device has low probability to detect the PSS and the SSS successively. In other words, when a legacy communication device fails to detect the PSS and the SSS, the legacy communication device will not try to camp on the network on a carrier in new carrier type. Therefore, a legacy communication device can go to the next possible carrier and no unnecessary time is spent on a carrier in new carrier type.

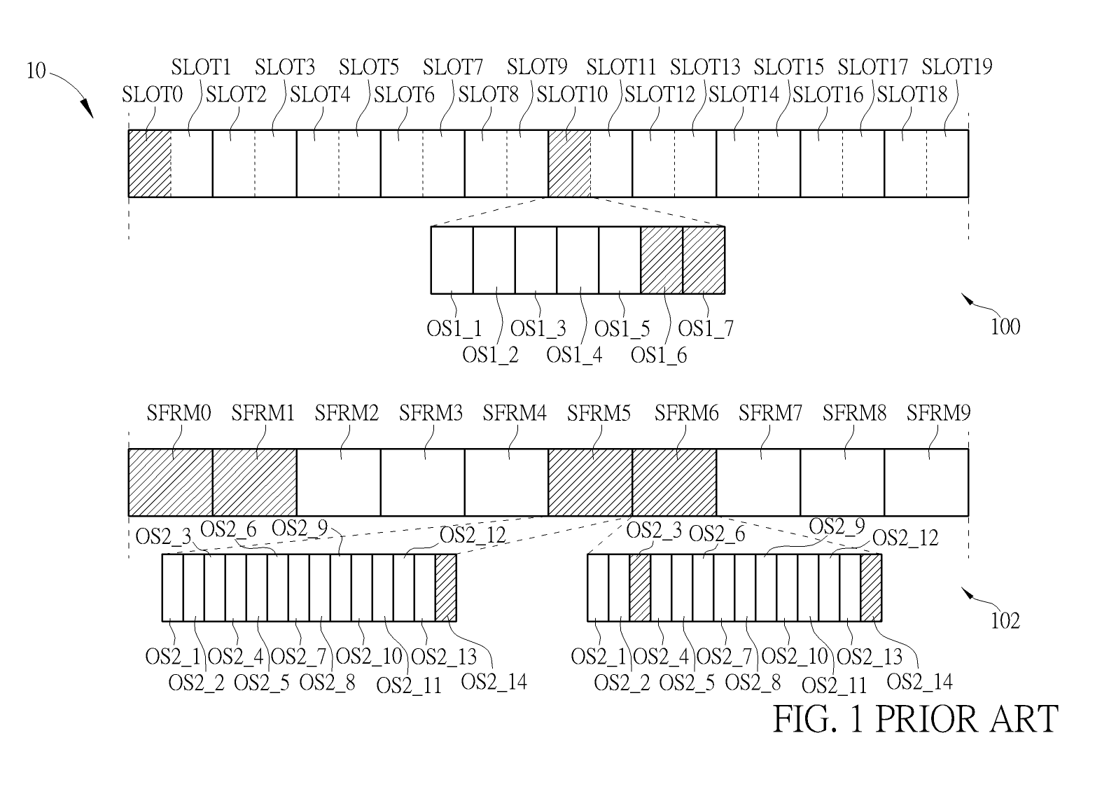

Note that, the process 70 is an example of the present invention, and those skilled in the art should readily make combinations, modifications and/or alterations on the abovementioned description and examples. The location for transmitting one PSS and one SSS within a frame are not limited. For example, one PSS and one SSS may be transmitted only in one of the slots SLOT0, SLOT10, and other slots in FIG. 1 for the frame structure type 1. One PSS and one SSS may be transmitted only in one of the combination of subframes SFRM1 and SFRM0, the combination of subframes SFRM6 and SFRM5, and other possible combinations in FIG. 1 for the frame structure type 2. Moreover, the OFDM symbols in the location used for transmitting the pair of the PSS and the SSS may be determined according to the conventional synchronization mechanism or the synchronization mechanism in the process 40 or even determined in a new specified location. Besides, subcarriers for transmitting the PSS and the SSS may also be determined according to the conventional synchronization mechanism or the synchronization mechanism in the process 50.

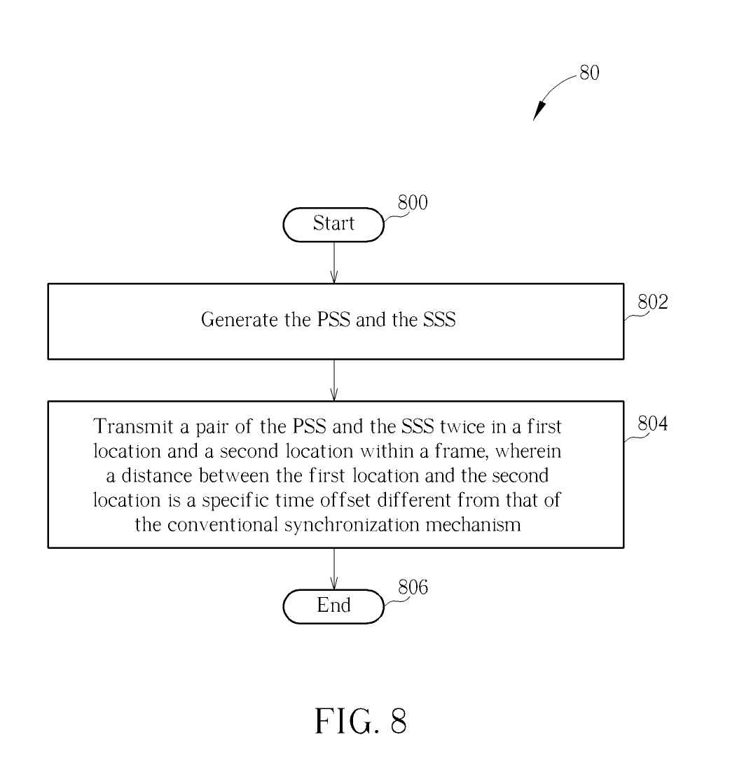

Please refer to FIG. 8, which is a flowchart of a process 80 according to an example of the present invention. The process 80 is utilized in the wireless communication system 20 shown in FIG. 8, for synchronization mechanism in a network supporting new carrier type. The process 80 can be utilized in the network and may be compiled into the program code 314. The process 80 includes the following steps:

Step 800: Start.

Step 802: Generate the PSS and the SSS.

Step 804: Transmit a pair of the PSS and the SSS twice in a first location and a second location within a frame, wherein a distance between the first location and the second location is a specific time offset different from that of the conventional synchronization mechanism.

Step 806: End.

According to the process 80, the network transmits a pair of the PSS and the SSS twice in a first and a second locations, and the distance between the first and second locations is the specific time offset which is different from that of the conventional synchronization mechanism. Therefore, a legacy communication device has low probability to detect the PSS and the SSS successively so as to avoid unnecessary search on a carrier in new carrier type.

Note that, the process 80 is an example of the present invention, and those skilled in the art should readily make combinations, modifications and/or alterations on the abovementioned description and examples. For example, one of the two transmissions for the pair of the PSS and the SSS may be performed according to the conventional synchronization mechanism, the synchronization mechanism in the process 40, the synchronization mechanism in the process 50 or their combination. For the type 1 frame structure, when the first transmission for the pair of the PSS and the SSS is performed according to the conventional synchronization mechanism and the specific time offset is set to be 2 slots, the first transmission for the PSS and the SSS may be performed in the slot SLOT0 in a frame as the conventional synchronization mechanism does and the second transmission for the PSS and the SSS is performed in the slot SLOT2 in the frame accordingly. Alternately, the second transmission for the PSS and the SSS may be performed in the slot SLOT10 in the frame as the conventional synchronization mechanism does, so that the first transmission for the PSS and the SSS is performed in the slot SLOT8 in the frame accordingly. Similarly, for the type 2 frame structure, when the first transmission for the pair of the PSS and the SSS is performed according to the conventional synchronization mechanism and the specific time offset is set to be 1 subframe, the first transmission for the pair of the PSS and the SSS may be performed in a pair of the subframes SFRM1 and SFRM0 in the frame as the conventional synchronization mechanism does, and the second transmission for the PSS and the SSS is performed in a pair of the subframes SFRM2 and SFRM1 in the frame accordingly. Alternately, the second transmission for the PSS and the SSS may be performed in the subframes SFRM6 and SFRM5 in the frame as the conventional synchronization mechanism does, and the first transmission for the PSS and the SSS is performed in the subframes SFRM5 and SFRM4 in the frame accordingly. In addition, OFDM symbols in the locations used for transmitting the pair of the PSS and the SSS may be determined according to the conventional synchronization mechanism or the synchronization mechanism in the process 40 or even determined by new specified symbols. Besides, subcarriers for transmitting the PSS and the SSS may also be determined according to the conventional synchronization mechanism or the synchronization mechanism in the process 50.

In another approach, the contents of the SSS in conventional process and the processes 40, 50, 70 and 80 can be defined according to the conventional generation mechanism or other methods modified from the conventional generation mechanism. These modifications would make a legacy communication device being unable to detect a modified SSS so as to avoid unnecessary search on a carrier in new carrier type.

In the conventional generation mechanism, a first sequence and a second sequence are used for generating the contents of a legacy SSS by means of mapping the first sequence and the second sequence are respectively to a set of even positions and a set of odd positions in the sequence contents of SSS. Note that, the first and second sequences are defined in a 3rd Generation Partnership Project (3GPP) specification, i.e. TS.36.211. Please refer to TS.36.211 for the detailed description and no further description is provided herein. The approach of the invention is to modify the mapping in the convention system. For example, the first sequence and the second sequence may also be used for generating the contents of the SSS but the first sequence and the second sequence are respectively mapped to a set of the odd positions and a set of the even positions in the sequence contents of SSS. That is, the mapping positions of the two sequences are exchanged.

Moreover, the contents of the SSS can be modified as the contents of the legacy SSS fully or partly masked by a pseudo-random noise (PN) sequence. The PN sequence can be obtained from any existing PN sequences of the current release 8 to 11 systems or from another PN sequence generator. For example, the PN sequence can be obtained from the PN sequences used for the cell specific reference signal in current release 8 to 11 systems.

In another approach, the contents of the PSS in the conventional process and the process 40, 50, 70 and 80 can be defined according to the conventional generation mechanism or other methods modified from the conventional synchronization mechanism. These modifications would make a legacy communication device being unable to detect a modified PSS so as to avoid unnecessary search on a carrier in new carrier type.

In the conventional generation mechanism, a third sequence and a fourth sequence are used for generating the contents of a legacy PSS by means of concatenating the third sequence and the fourth sequence in a forward order. Note that, the third and fourth sequences are defined in a 3GPP specification, i.e. TS.36.211. Please refer to TS.36.211 for the detailed description and no further description is provided herein. The approach of the invention is to concatenate the third sequence and the fourth sequences in a backward order. That is, the two sequences are exchanged while concatenating.

For another case of modification from the conventional synchronization mechanism, the contents of the PSS are the contents of a legacy PSS masked with a PN sequence or an orthogonal sequence. The PN sequence can be obtained from any existing PN sequences of the current release 8 to 11 systems or from another PN sequence generator. For example, the PN sequence can be obtained from the PN sequences used for the cell specific reference signal in current release 8 to 11 systems. In case an orthogonal code is used, the orthogonal sequence may be, for example, a Hadamard sequence. These modification should reduce cross-correlation between a modified PSS and a legacy PSS or even become zero. In other words, these modifications should make the correlation between a modified PSS and a legacy PSS as low as possibly. At least these modifications should make the correlation between a modified PSS and a legacy PSS lower than the autocorrelation of the legacy PSS.

Each one of the abovementioned methods for defining the contents of the PSS and/or the SSS can be applied to the process 40, 50, 70 and 80, and can also be applied to the conventional synchronization mechanism to generate the contents of the PSS and/or the SSS. In such a situation, a legacy communication fails to decode the contents of the PSS and/or the SSS transmitted by the network and will not try to camp on the carrier in new carrier type.

In the present invention, the network generates the PSS and/or the SSS by masking the legacy PSS and/or the legacy SSS with the PN code or the orthogonal code. Or the network transmits one PSS and one SSS only one time within a frame or transmits one PSS and one SSS on different subcarriers. Therefore, a legacy communication device cannot detect the PSS and/or the SSS or correctly decode the contents of the PSS and/or the SSS, so that the legacy communication device will not go on its trial on a carrier in new carrier type, to save its time on the network search.

To sum up, the present invention provides a method for synchronization mechanism, so that a communication device not supporting a new carrier type will spend less or even no time on a carrier in new carrier type to save its network search time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for synchronization mechanism in a wireless communication network supporting new carrier type, the method comprising:
generating a primary synchronization signal (PSS) and a secondary synchronization signal (SSS);
transmitting a pair of the PSS and the SSS on a first carrier by a first mechanism; and
transmitting a pair of the PSS and the SSS on a second carrier by a second mechanism;
wherein the second carrier is of new carrier type.

2. The method of claim 1, wherein the PSS of the second mechanism is transmitted on a first orthogonal frequency-division multiplexing (OFDM) symbol in at least one location in a frame, and the SSS of the second mechanism is transmitted on a second OFDM symbol in at least one location in the frame, wherein the first OFDM symbol is prior to the second OFDM symbol in time.

3. The method of claim 1, wherein the PSS of the second mechanism is transmitted starting from a first subcarrier and the SSS of the second mechanism is transmitted starting from a second subcarrier, wherein the first subcarrier and the second subcarrier have a frequency offset.

4. The method of claim 1, wherein the pair of the PSS and the SSS of the second mechanism is transmitted in only one pair of locations in a frame.

5. The method of claim 1, wherein the pair of the PSS and the SSS of the second mechanism is transmitted twice in a first pair of locations and a second pair of locations in a frame, wherein a time distance between the first pair of locations and the second pair of locations is different from that in the first mechanism.

6. The method of claim 1, wherein a first sequence and a second sequence are used for generating the contents of the SSS of the first mechanism and the contents of the SSS of the second mechanism, wherein the first sequence and the second sequence are respectively mapped to a set of even positions and a set of odd positions in the sequence contents of the SSS of the first mechanism and respectively mapped to a set of odd positions and a set of even positions in the sequence contents of the SSS of the second mechanism.

7. The method of claim 1, wherein the SSS of the second mechanism is the SSS of the first mechanism masked with a pseudo-random noise (PN) sequence.

8. The method of claim 7, wherein the PN sequence is obtained from any existing PN sequences in the system or from another PN sequence generator.

9. The method of claim 1, wherein the SSS of the second mechanism comprises:
a first part of the SSS of the first mechanism, masked with a pseudo-random noise (PN) sequence or an orthogonal sequence; and
a second part of the SSS of the first mechanism, not masked with the PN sequence or the orthogonal sequence.

10. The method of claim 9, wherein the PN sequence is obtained from any existing PN sequences in the system.

11. The method of claim 1, wherein the PSS of the second mechanism is the PSS of the first mechanism masked with a pseudo-random noise (PN) sequence or an orthogonal sequence.

12. The method of claim 11, wherein the PN sequence is obtained from any existing PN sequences in the system or the orthogonal sequence is a Hadamard sequence.

13. The method of claim 11, wherein the correlation between the PSS of the second mechanism and the PSS of the first mechanism is lower than the autocorrelation of the PSS of the first mechanism.

14. The method of claim 1, wherein a first sequence and a second sequence are used for generating the contents of the PSS of the first mechanism and the contents of the PSS of the second mechanism, wherein the first sequence and the second sequence are concatenated in a forward order for the PSS of the first mechanism and concatenated in a backward order for the PSS of the second mechanism.

15. A communication apparatus for a wireless communications system, comprising:
a processing means;
a storage unit; and
a program code, stored in the storage unit, wherein the program code instructs the processing means to execute the following steps:
generating a primary synchronization signal (PSS) and a secondary synchronization signal (SSS);
transmitting a pair of the PSS and the SSS on a first carrier by a first mechanism; and
transmitting a pair of the PSS and the SSS on a second carrier by a second mechanism;
wherein the second carrier is a new carrier type.

16. The communication apparatus of claim 15, wherein the PSS of the second mechanism is transmitted on a first orthogonal frequency-division multiplexing (OFDM) symbol in at least one location in a frame, and the SSS of the second mechanism is transmitted on a second OFDM symbol in at least one location in the frame, wherein the first OFDM symbol is prior to the second OFDM symbol in time; or the PSS of the second mechanism is transmitted starting from a first subcarrier and the SSS of the second mechanism is transmitted starting from a second subcarrier, wherein the first subcarrier and the second subcarrier have a frequency offset.

17. The communication apparatus of claim 15, wherein the pair of the PSS and the SSS of the second mechanism is transmitted in only one pair of locations in a frame; or the pair of the PSS and the SSS of the second mechanism is transmitted twice in a first pair of locations and a second pair of locations in a frame, wherein a time distance between the first pair of locations and the second pair of locations is different from that in the first mechanism.

18. The communication apparatus of claim 15, wherein a first sequence and a second sequence are used for generating the contents of the SSS of the first mechanism and the contents of the SSS of the second mechanism, wherein the first sequence and the second sequence are respectively mapped to a set of even positions and a set of odd positions in the sequence contents of the SSS of the first mechanism and respectively mapped to a set of odd positions and a set of even positions in the sequence contents of the SSS of the second mechanism.

19. The communication apparatus of claim 15, wherein the SSS of the second mechanism is the SSS of the first mechanism masked with a pseudo-random noise (PN) sequence.

20. The communication apparatus of the claim 19, wherein the PN sequence is obtained from any existing PN sequences in the system or from another PN sequence generator.

21. The communication apparatus of claim 15, wherein the SSS of the second mechanism comprises:
a first part of the SSS of the first mechanism, masked with a pseudo-random noise (PN) sequence or an orthogonal sequence; and
a second part of the SSS of the first mechanism, not masked with the PN sequence or the orthogonal sequence.

22. The communication apparatus of claim 21, wherein the PN sequence is obtained from any existing PN sequences in the system.

23. The communication apparatus of claim 15, wherein the PSS of the second mechanism is the PSS of the first mechanism masked with a pseudo-random noise (PN) sequence or an orthogonal sequence.

24. The communication apparatus of claim 23, wherein the PN sequence is obtained from any existing PN sequences in the system or the orthogonal sequence is a Hadamard sequence.

25. The communication apparatus of claim 23, wherein the correlation between the PSS of the second mechanism and the PSS of the first mechanism is lower than the autocorrelation of the PSS of the first mechanism.

26. The communication apparatus of claim 15, wherein a first sequence and a second sequence are used for generating the contents of the PSS of the first mechanism and the contents of the PSS of the second mechanism, wherein the first sequence and the second sequence are concatenated in a forward order for the PSS of the first mechanism and concatenated in a backward order for the PSS of the second mechanism.
